(19) United States
(12) Patent Application Publication
(10) Pub. No.: US 2016/0086349 A1
(43) Pub. Date: Mar. 24, 2016

(54) TRACKING HAND POSE USING FOREARM-HAND MODEL

(71) Applicant: Microsoft Corporation, Redmond, WA (US)

(72) Inventors: Jamie Daniel Joseph Shotton, Cambridge (GB); Duncan Paul Robertson, Cambridge (GB); Jonathan James Taylor, Toronto (CA); Cem Keskin, Cambridge (GB); Shahram Izadi, Cambridge (GB); Andrew William Fitzgibbon, Cambridge (GB)

(21) Appl. No.: 14/494,467

(22) Filed: Sep. 23, 2014

(51) Int. Cl. G06T 7/20; G06T 7/00; G06T 13/40; G06T 19/00; G06T 19/20; G06F 3/01; G06T 17/00

(52) U.S. Cl. CPC G06T 7/2046; G06F 3/017; G06T 7/0081; G06T 17/00; G06T 19/006; G06T 19/20; G06T 13/40; G06T 2207/30196; G06T 2207/30204; G06T 2200/04; G06T 2207/10016; G06T 2207/30241

(57) ABSTRACT

Tracking hand pose from image data is described, for example, to control a natural user interface or for augmented reality. In various examples an image is received from a capture device, the image depicting at least one hand in an environment. For example, a hand tracker accesses a 3D model of a hand and forearm and computes pose of the hand depicted in the image by comparing the 3D model with the received image.

### BACKGROUND

Real-time articulated hand tracking from image data has the potential to open up new human-computer interaction scenarios. However, the dexterity and degrees-of-freedom of human hands makes visual tracking of a fully articulated hand challenging.

The embodiments described below are not limited to implementations which solve any or all of the disadvantages of known hand/body pose trackers.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Tracking hand pose from image data is described, for example, to control a natural user interface or for augmented reality. In various examples an image is received from a capture device, the image depicting at least one hand in an environment. For example, a hand tracker accesses a 3D model of a hand and forearm and computes pose of the hand depicted in the image by comparing the 3D model with the received image.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of tracking hand pose using a tablet computing device;

FIG. 2 is a schematic diagram of a hand tracker as part of a desk top computing system;

FIG. 3 is a schematic diagram of a 3D model of a hand and forearm;

FIG. 4 is a schematic diagram of a kinematic skeleton of a hand and forearm;

FIG. 5 is a schematic diagram of a hand tracker;

FIG. 6 is a flow diagram of a method at the hand tracker of FIG. 5;

FIG. 7 illustrates an exemplary computing-based device in which embodiments of a hand tracker may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

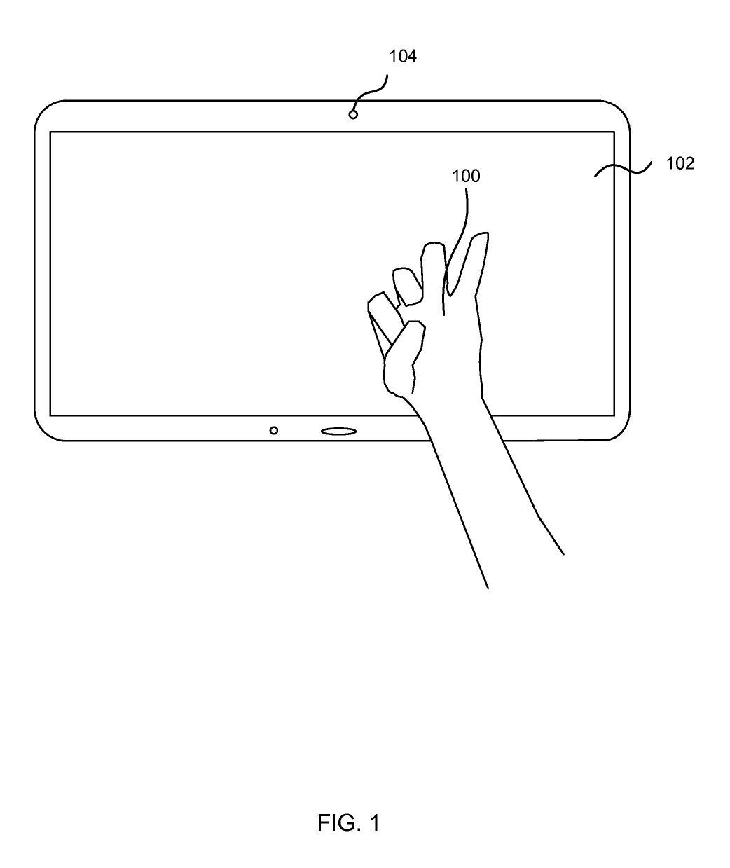

FIG. 1 is a schematic diagram of tracking hand pose using an image capture device 104 which is integral with a tablet computing device 102. A user makes hand gestures and movements in a field of view of the capture device 104 and FIG. 1 shows a user's hand 100 above the tablet computing device 102. Images from the capture device 104 are analyzed in real time by hand tracking software and/or hardware in the tablet computing device 102 and/or using functionality in the cloud or at another computing device in communication with the table computing device 102 by wired or wireless communication. The analysis results in a tracked pose of the hand. The term “hand pose” is used here to refer to a global position and global orientation of a hand and also a plurality of joint angles or positions of the hand and fingers. For example, hand pose may comprise more than 10 or more than 20 degrees of freedom depending on the detail and complexity of a hand model used. In one example the pose vector comprises a global translation component, a global rotation component, and a hierarchy of joint transformations. In an example each joint transformation may comprise three parameters each for scale, rotation, and translation. Joints are arranged in a kinematic skeleton hierarchy, and each joint's transformation is defined relative to its parent.

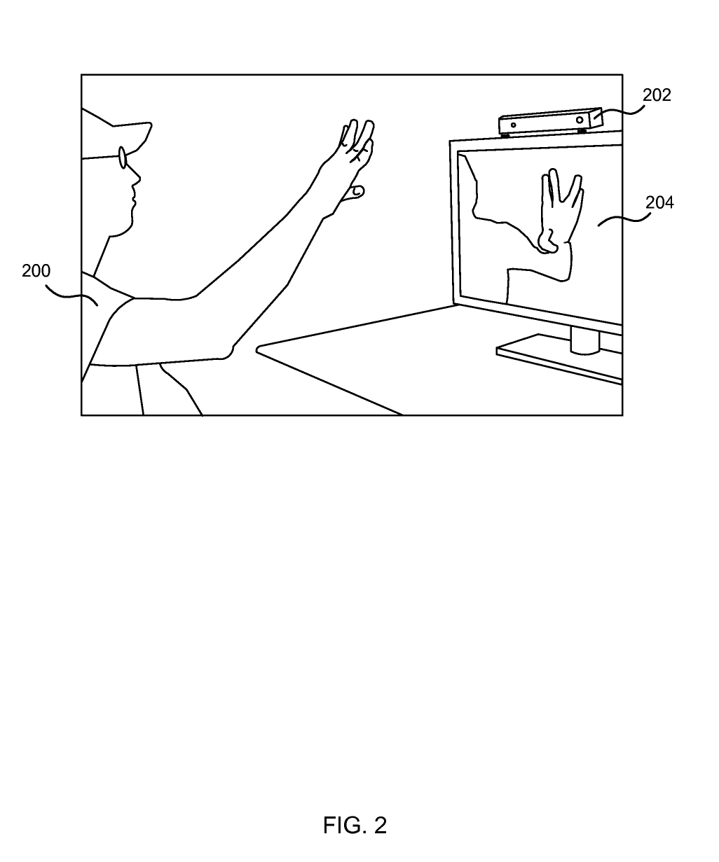

In another example, the hand tracking software and/or hardware is used in a desktop computing environment, or a gaming environment, as illustrated in FIG. 2. Here a user 200 makes complex hand shapes in front of a capture device 202. Results of the hand tracking are shown in real time on a display screen 204 in this example.

The hand tracking hardware and/or software of the examples described in this document differs from previous hand trackers because a 3D model of a hand and forearm is used, even though the goal is only to track hands rather than hands and forearms. Despite this being counterintuitive, the use of a 3D model of a hand and forearm to track hand pose has been found to give improved accuracy. For example, a region of interest is extracted from observed images to identify those image elements which depict the hand. It is recognized herein that region of interest extraction is flawed in practice and so regions of interest comprise image elements depicting other surfaces such as the wrist and forearm. By using a 3D model of a hand and forearm it is possible to account for image elements in the region of interest which depict the forearm and so achieve improved accuracy.

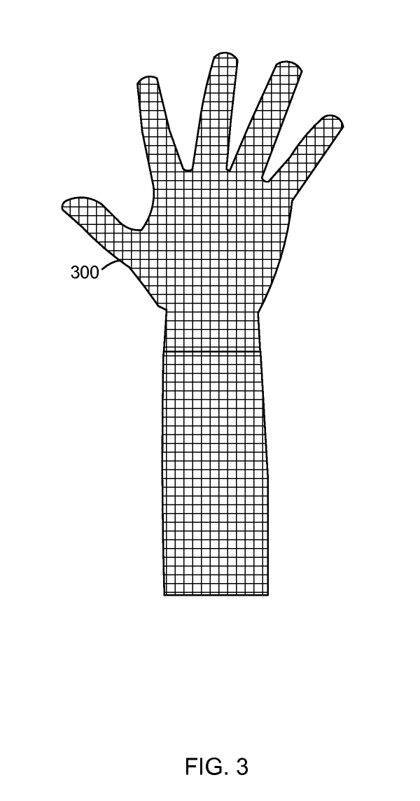

An example of a 3D model of a hand and forearm which may be used in the examples described herein is given in FIG. 3. Note this is a 2D drawing of a 3D mesh model. The 3d model of the hand and forearm may represent the hand and forearm in a base pose. The model may be a mesh model comprising tessellating triangles, squares, rectangles or other shapes covering a 3D surface of the hand and forearm. A mesh model may be stored by storing a vector of coordinates of vertices of the mesh or in other ways. However, it is not essential to use a mesh model. Other types of 3D model of the hand and forearm may be used such as a subdivision surface model, an implicit surface, etc.

The 3D model of the hand may also comprise an articulated model (referred to as a kinematic skeleton) which represents the relationship between joints and bones of a hand and how the joints operate. The kinematic skeleton may be used in conjunction with the 3D mesh model. For example, given a candidate pose a forward kinematic process is applied to the kinematic skeleton to calculate the individual joint angles of the digits and thumb. These angles may then be applied to the 3D mesh model to give the 3D mesh the candidate pose, for example using linear blend skinning. A renderer may then render a synthetic image from the 3D mesh in its candidate pose using well known rendering processes. The kinematic skeleton contains knowledge about how much and in what ways joints of the hand operate and this ensures that hand poses which would be impossible for a human to achieve are avoided.

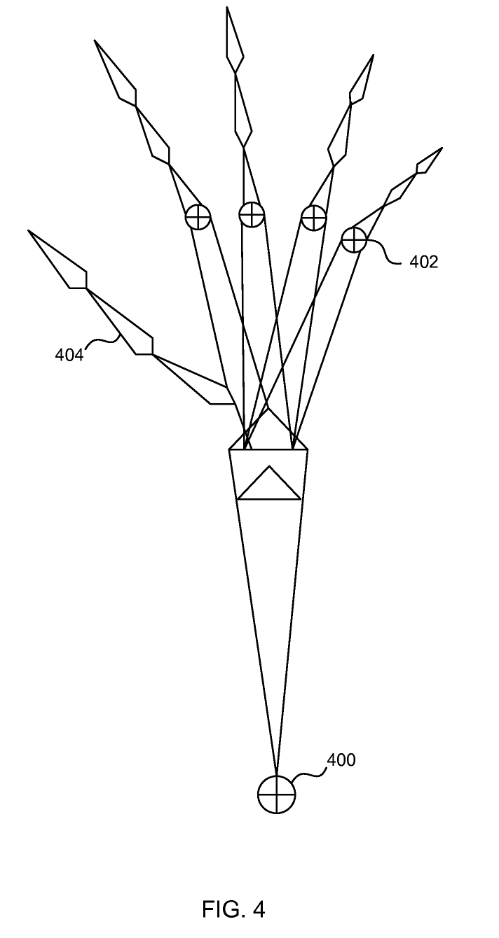

A schematic diagram of a kinematic skeleton of a hand is given in FIG. 4 although note that this is a 2D drawing whereas the actual model is a 3D model. The model comprises, for each finger, three bone lengths and one joint angle 402; as well as three bone lengths for the thumb. Joint angles where the each finger and where the thumb reaches the wrist are also modelled. A finger is represented as comprising three bones, namely proximal, middle and distal phalanges. From fingertip to palm these bones are interconnected by a 1 degree of freedom revolute joint called the distal interphalangeal (DIP) joint, a 1 degree of freedom revolute proximal interphalangeal (PIP) joint and a two degree of freedom spherical joint called the metacarpophalangeal (MCP) joint.

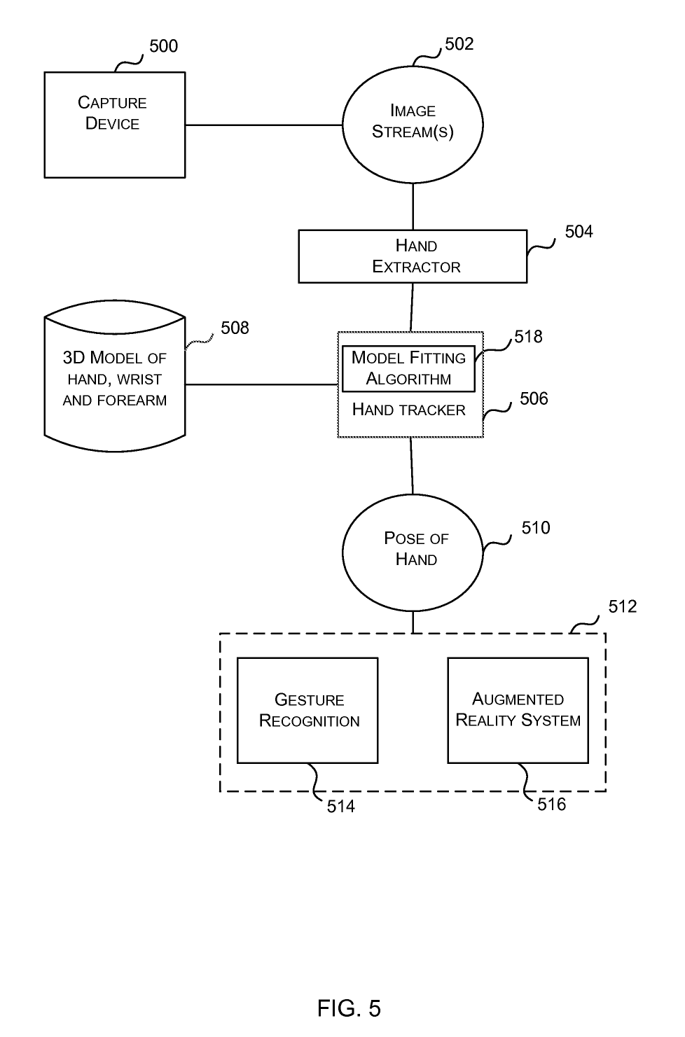

FIG. 5 is a schematic diagram of a hand tracker 502 which may be integral with a tablet computer such as that of FIG. 1 or used in any other suitable operating environment as mentioned above (e.g. personal computer, game system, cloud server, mobile phone). The hand tracker 502 takes as input, images 502 from one or more capture devices 500. The images depict one or more hands in a field of view of the capture device which may comprise other objects, surfaces, people or animals. Note that the user is not constrained by having to position his or her hand in a particular way relative to the capture device in order that the capture device captures images of his or her hand and not his or her forearm. This improves usability for the end user who is able to move his or her hands in a natural manner. In addition, the user is not required to wear a sleeve of a specified color, a wrist band or any sensors on his or her hands. This improves usability and enables natural hand movement.

The capture device 500 is able to capture one or more streams of images. For example, the capture device 500 comprises a depth camera of any suitable type such as time of flight, structured light, stereo, speckle decorrelation. In some examples the capture device 500 comprises a color (RGB) video camera in addition to, or in place of a depth camera. For example, data from a color video camera may be used to compute depth information. The images 500 input to the hand/body tracker comprise frames of image data such as red, green and blue channel data for a color frame, depth values from a structured light sensor, three channels of phase data for a frame from a time of flight sensor, pairs of stereo images from a stereo camera, speckle images from a speckle decorrelation sensor.

The hand tracker 506 produces as output a stream of tracked hand pose values 510. The pose may be expressed as a vector (or other format) of values, one for each degree of freedom of the pose being tracked. For example, 10 or more, or 20 or more values. In one example, the pose vector comprises 3 degrees of freedom for a global rotation component, 3 degrees of freedom for a global translation component, and 4 degrees of freedom for each joint transformation).

In some examples the hand tracker 506 sends output to a display such as the display shown in FIG. 2 although this is not essential. The output may comprise a synthetic image of the hand being tracked, rendered from the 3D hand model according to a current tracked pose of the user's hand.

In some examples the hand tracker 506 sends the tracked hand pose 510 to a downstream application or apparatus 512 such as a gesture recognition system 514, an augmented reality system 516. These are examples only and other downstream applications or apparatus may be used. The downstream application or apparatus 512 is able to use the tracked hand pose 510 to control and/or update the downstream application or apparatus.

A hand extractor 504 pre-processes the images 502 by extracting one or more regions of interest each depicting a hand. For example, this is done using well known foreground extraction image processing techniques. For example, the foreground extraction technology may use color information in color images captured by the capture device 102 to detect and extract image elements depicting the user's hand. In another example, the images 502 are depth images and a skeletal tracker is used to identify regions of the depth images corresponding to hands.

It is recognized herein that the hand extractor 504 cannot output perfect results. That is, the regions of interest extracted by the hand extractor 504 will typically comprise at least some image elements which depict a user's forearm as well as image elements depicting the hand. For example, this is because the hand extractor is not aided by the user wearing a special sleeve, orienting his or her hand in a special way with respect to the capture device, wearing sensors on his or her hand, or painting or coloring his or her hand in a specified way.

The hand tracker 506 comprises a model fitting algorithm 518 which searches for the current hand pose by making comparisons between the regions of interest depicting a hand and the 3D model of the hand and forearm 508. A score may be computed on the basis of the comparison. Any suitable model fitting algorithm 518 may be used. Even though the extracted regions of interest depict mainly the user's hand, the comparison is with a 3D model of a hand and forearm. In this way, image elements in the region of interest which depict forearm can be taken into account. This is found to give greatly improved accuracy because, experimental results found that where a 3D model of a hand is used (without including forearm) the search for the current hand pose often reaches an incorrect local solution rather than the correct global solution. For example, without including the forearm in the model, the result of model fitting will often appear flipped upside-down or will slide up and down the forearm.

As mentioned above, any suitable model fitting algorithm 518 may be used. The model fitting algorithm 518 searches for a good fit between the model and the observed images using a comparison process. For example, by rendering synthetic images from the model and comparing those with the observed images or by fitting observed image elements directly to surfaces of the 3D model.

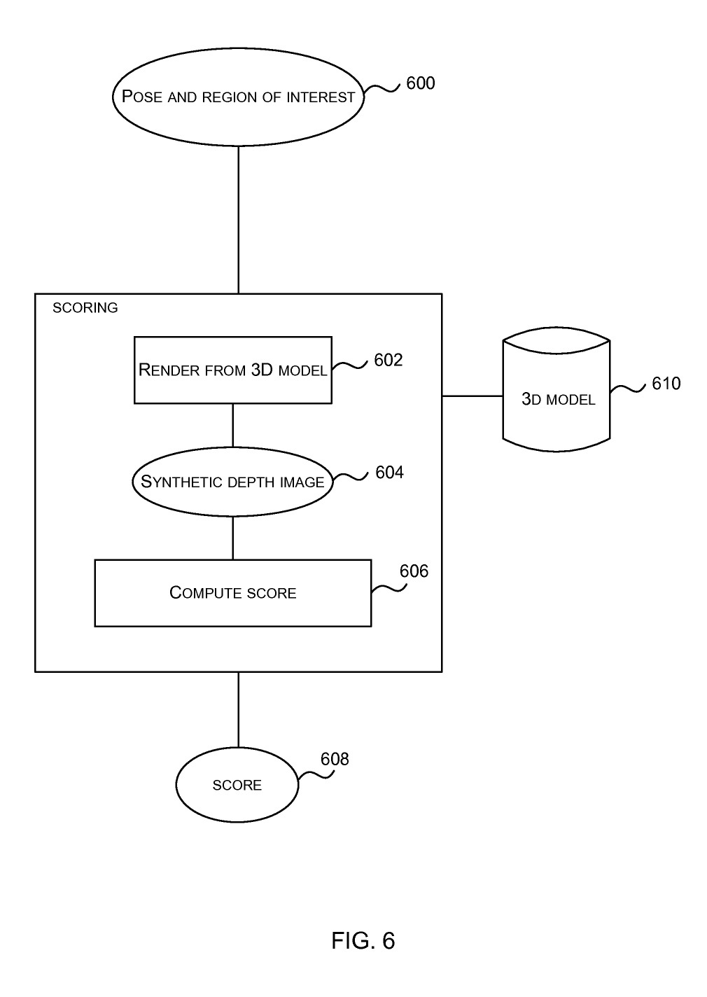

The comparison process uses a distance metric or distance function to assess how well the model and the observed image agree. For example, the metric may comprise computing a sum over image pixels of the absolute or squared difference between the rendered image and the observed image. In some examples the sum has a robust penalty term applied such as Geman-McClure, or Cauchy, to help reduce the effect of outliers. In another example the distance metric is related to a pixel-wise L1 norm or L2 norm. An example of a comparison process is given below with reference to FIG. 6.

The model fitting algorithm 518 may use an optimization process to facilitate the search using search strategies such as stochastic optimization or gradient based optimization.

In an example, the model fitting algorithm comprises a machine learning system which takes regions of interest and computes a distribution over hand pose. Samples from the distribution are then taken and used to influence an optimization process to find a pose which matches the observed images to synthetically rendered images from the model. For example, the optimizer may be a stochastic optimizer or a gradient-based optimizer.

A stochastic optimizer is an iterative process of searching for a solution to a problem, where the iterative processes uses randomly generated variables. The stochastic optimizer 208 may be a particle swarm optimizer, a genetic algorithm process, a hybrid of a particle swarm optimizer and a genetic algorithm process, or any other stochastic optimizer which iteratively refines a pool of candidate poses 214. A particle swarm optimizer is a way of searching for a solution to a problem by iteratively trying to improve a candidate solution in a way which takes into account other candidate solutions (particles in the swarm). A population of candidate solutions, referred to as particles, are moved around in the search-space according to mathematical formulae. Each particle's movement is influenced by its local best known position but, is also guided toward the best known positions in the search-space, which are updated as better positions are found by other particles. This is expected to move the swarm toward the best solutions. A genetic algorithm process is a way of searching for a solution to a problem by generating candidate solutions using inheritance, splicing, and other techniques inspired by evolution.

Alternatively, or in addition, the functionality of the hand tracker can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

FIG. 6 is a flow diagram of a scoring process which may be carried out by the model fitting algorithm 518 or any of the other components of the hand tracker 506. The score may be a quality score indicating how good a candidate pose is. A pose and a region of interest 600 are input to the scoring process. The pose is used by a renderer to render 602 a synthetic depth image 604 from the 3D model 610. The synthetic depth image is compared with the region of interest to compute 606 a score and the score is output 608. The score may be computed using a distance metric as described above. The renderer may take into account occlusions. Because the 3D model comprises both a hand and forearm, it is able to account for any observed forearm image elements in the region of interest. In this way accuracy is greatly improved over previous approaches where a hand is modeled without the forearm, and prevent problems such as the hand model flipping upside-down or sliding up and down the forearm.

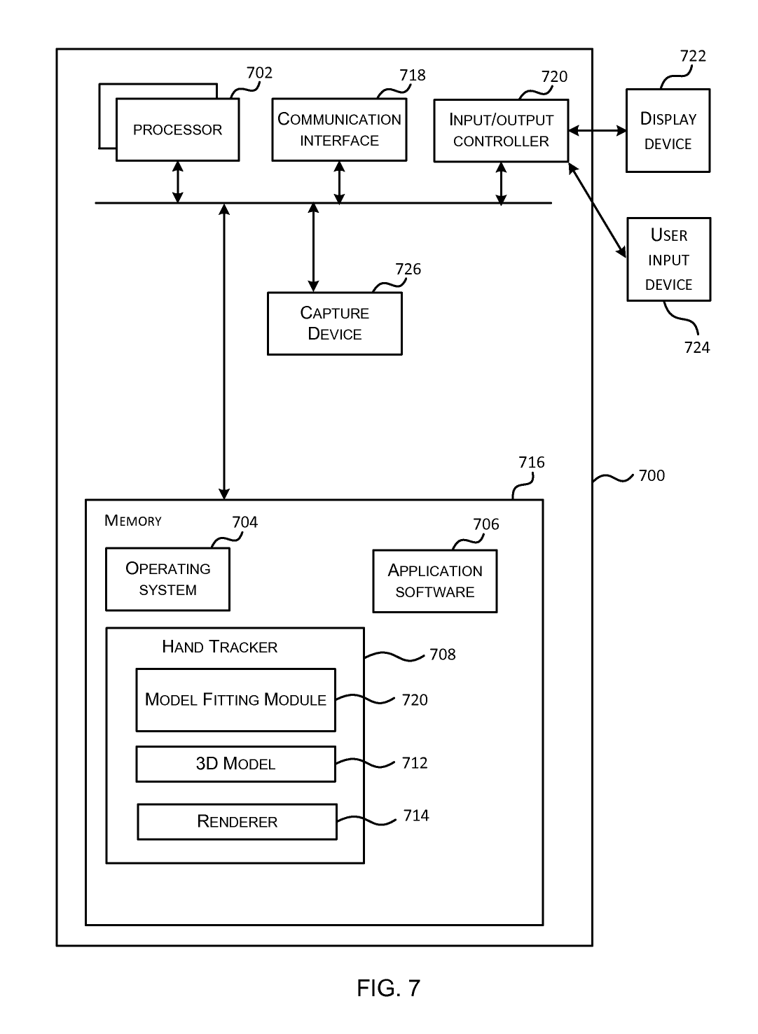

FIG. 7 illustrates various components of an exemplary computing-based device 704 which may be implemented as any form of a computing and/or electronic device, and in which embodiments of a hand tracker may be implemented. For example, a mobile phone, a tablet computer, a laptop computer, a personal computer, a web server, a cloud server.

Computing-based device 700 comprises one or more processors 702 which may be microprocessors, controllers or any other suitable type of processors for processing computer executable instructions to control the operation of the device in order to accurately track pose of hands or bodies in real time. In some examples, for example where a system on a chip architecture is used, the processors 702 may include one or more fixed function blocks (also referred to as accelerators) which implement a part of the method of hand tracking or any of FIGS. 5 to 6 in hardware (rather than software or firmware). Platform software comprising an operating system 704 or any other suitable platform software may be provided at the computing-based device to enable application software 706 to be executed on the device. Memory 716 stores candidate poses, regions of interest, image data, tracked pose and/or other data. A hand tracker 708 comprises instructions stored at memory 716 to execute hand tracking as described herein. A model fitting module 710 comprises instructions stored at memory 716 to execute model fitting as described herein. The hand tracker 708 comprises renderer 714 which may use a parallel computing unit implemented in processors 702.

The computer executable instructions may be provided using any computer-readable media that is accessible by computing based device 700. Computer-readable media may include, for example, computer storage media such as memory 716 and communications media. Computer storage media, such as memory 716, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 716) is shown within the computing-based device 700 it will be appreciated that the storage may be distributed or located remotely and accessed via a network or other communication link (e.g. using communication interface 718).

The computing-based device 700 also comprises an input/output controller 720 arranged to output display information to a display device 722 which may be separate from or integral to the computing-based device 700. The display information may provide a graphical user interface. The input/output controller 720 is also arranged to receive and process input from one or more devices, such as a user input device 724 (e.g. a mouse, keyboard, microphone or other sensor). In some examples the user input device 724 may detect voice input, user gestures or other user actions and may provide a natural user interface (NUI). In an embodiment the display device 722 may also act as the user input device 724 if it is a touch sensitive display device. The input/output controller 720 may also output data to devices other than the display device, e.g. a locally connected printing device.

In the example of FIG. 7 the computing device 700 has an integral capture device 726 such as the capture device 500 of FIG. 5. However, this capture device may be external to the computing device 700 in some examples.

Any of the input/output controller 720, display device 722 and the user input device 724 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, rgb camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

In an example there is a method of tracking hand pose comprising:

receiving an image depicting at least one hand in an environment;

accessing a 3D model of a hand and forearm;

computing pose of the hand depicted in the image by comparing the 3D model with the received image.

For example the method may comprise extracting a region of interest from the image, the region of interest comprising image elements depicting the hand, and wherein comparing the 3D model with the received image comprises comparing the 3D model with the region of interest.

For example, the method described in the paragraph immediately above comprises extracting the region of interest from the image so as to comprise image elements the majority of which depict the hand.

For example, the method described in the paragraph immediately above comprises extracting the region of interest imperfectly so that at least some of the image elements in the region of interest depict the forearm.

In examples the 3D model of the hand and forearm comprises a kinematic skeleton of the hand and forearm and a model of a 3D surface of a hand and forearm.

The examples described above may comprise comparing the 3D model with the received image by rendering a synthetic image from the 3D model and comparing the synthetic image with the received image.

The examples described above may comprise comparing the 3D model with the received image by comparing image elements of the received image with surfaces of the 3D model.

In various examples a hand tracker comprises:

an input interface arranged to receive an image depicting at least one hand in an environment;

a processor arranged to access a 3D model of a hand, wrist and forearm; and

a model fitting component arranged to compute pose of the hand depicted in the region of interest by comparing the 3D model with the received image.

The hand tracker described in the paragraph above may have the processor arranged to extract a region of interest from the image, the region of interest comprising image elements depicting the hand, and wherein comparing the 3D model with the received image comprises comparing the 3D model with the region of interest.

The hand tracker of described above may have the processor arranged to extract the region of interest from the image so as to comprise image elements the majority of which depict the hand.

In an example, the hand tracker has a 3D model of the hand and forearm comprising a kinematic skeleton of the hand and forearm and a model of a 3D surface of a hand and forearm.

In an example the model fitting component is arranged to render a synthetic image from the 3D model and compare the synthetic image with the received image.

In an example the model fitting component is arranged to compare image elements of the received image with surfaces of the 3D model.

In an example there is one or more tangible device-readable media with device-executable instructions that, when executed by a computing system, direct the computing system to:

receive a depth image depicting at least one hand in an environment;

access a 3D model of a hand and forearm; and

compute pose of the hand depicted in the image by comparing the 3D model with the received image.

For example, the device-readable media has device-executable instructions that, when executed by a computing system, direct the computing system to extract a region of interest from the image, the region of interest comprising image elements depicting the hand, and wherein comparing the 3D model with the received image comprises comparing the 3D model with the region of interest.

For example, the device-readable media has device-executable instructions that, when executed by a computing system, direct the computing system to extract the region of interest from the image so as to comprise image elements the majority of which depict the hand.

For example, the device-readable media has device-executable instructions that, when executed by a computing system, direct the computing system to extract a region of interest from the image, the region of interest being extracted imperfectly so that at least some of the image elements in the region of interest depict the forearm.

For example, the device-readable media has device-executable instructions that, when executed by a computing system, direct the computing system to access a 3D model of the hand and forearm comprising a kinematic skeleton of the hand and forearm and a model of a 3D surface of a hand and forearm.

For example, the device-readable media has device-executable instructions that, when executed by a computing system, direct the computing system to render a synthetic image from the 3D model and compare the synthetic image with the received image.

For example, the device-readable media has device-executable instructions that, when executed by a computing system, direct the computing system to compare image elements of the received image with surfaces of the 3D model.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method of tracking hand pose comprising:
receiving an image depicting at least one hand in an environment;
accessing a 3D model of a hand and forearm;
computing pose of the hand depicted in the image by comparing the 3D model with the received image.

2. The method of claim 1 comprising extracting a region of interest from the image, the region of interest comprising image elements depicting the hand, and wherein comparing the 3D model with the received image comprises comparing the 3D model with the region of interest.

3. The method of claim 2 wherein the region of interest is extracted from the image so as to comprise image elements the majority of which depict the hand.

4. The method of claim 3 where the region of interest is extracted imperfectly so that at least some of the image elements in the region of interest depict the forearm.

5. The method of claim 1 wherein the 3D model of the hand and forearm comprises a kinematic skeleton of the hand and forearm and a model of a 3D surface of a hand and forearm.

6. The method of claim 1 wherein comparing the 3D model with the received image comprises rendering a synthetic image from the 3D model and comparing the synthetic image with the received image.

7. The method of claim 1 wherein comparing the 3D model with the received image comprises comparing image elements of the received image with surfaces of the 3D model.

8. A hand tracker comprising:
an input interface arranged to receive an image depicting at least one hand in an environment;
a processor arranged to access a 3D model of a hand, wrist and forearm; and
a model fitting component arranged to compute pose of the hand depicted in the region of interest by comparing the 3D model with the received image.

9. The hand tracker of claim 8 wherein the processor is arranged to extract a region of interest from the image, the region of interest comprising image elements depicting the hand, and wherein comparing the 3D model with the received image comprises comparing the 3D model with the region of interest.

10. The hand tracker of claim 9 wherein the processor is arranged to extract the region of interest from the image so as to comprise image elements the majority of which depict the hand.

11. The hand tracker of claim 8 wherein the 3D model of the hand and forearm comprises a kinematic skeleton of the hand and forearm and a model of a 3D surface of a hand and forearm.

12. The hand tracker of claim 8 wherein the model fitting component is arranged to render a synthetic image from the 3D model and compare the synthetic image with the received image.

13. The hand tracker of claim 8 wherein the model fitting component is arranged to compare image elements of the received image with surfaces of the 3D model.

14. One or more tangible device-readable media with device-executable instructions that, when executed by a computing system, direct the computing system to:
receive a depth image depicting at least one hand in an environment;
access a 3D model of a hand and forearm; and
compute pose of the hand depicted in the image by comparing the 3D model with the received image.

15. The device-readable media of claim 14 with device-executable instructions that, when executed by a computing system, direct the computing system to extract a region of interest from the image, the region of interest comprising image elements depicting the hand, and wherein comparing the 3D model with the received image comprises comparing the 3D model with the region of interest.

16. The device-readable media of claim 14 with device-executable instructions that, when executed by a computing system, direct the computing system to extract the region of interest from the image so as to comprise image elements the majority of which depict the hand.

17. The device-readable media of claim 14 with device-executable instructions that, when executed by a computing system, direct the computing system to extract a region of interest from the image, the region of interest being extracted imperfectly so that at least some of the image elements in the region of interest depict the forearm.

18. The device-readable media of claim 14 with device-executable instructions that, when executed by a computing system, direct the computing system to access a 3D model of the hand and forearm comprising a kinematic skeleton of the hand and forearm and a model of a 3D surface of a hand and forearm.

19. The device-readable media of claim 14 with device-executable instructions that, when executed by a computing system, direct the computing system to render a synthetic image from the 3D model and compare the synthetic image with the received image.

20. The device-readable media of claim 14 with device-executable instructions that, when executed by a computing system, direct the computing system to compare image elements of the received image with surfaces of the 3D model.
